(19) United States
(12) Patent Application Publication
(10) Pub. No.: US 2015/0287033 A1
(43) Pub. Date: Oct. 8, 2015

(54) METHODS AND SYSTEMS FOR TESTING SUCCESS OF REMOTE PERSONALIZATION

(71) Applicant: MasterCard International Incorporated, Purchase, NY (US)

(72) Inventors: Nealle Andrew Page, Stamford (GB); German Blanco, London (GB); Colin Tanner, Middlesex (GB)

(73) Assignee: MasterCard International Incorporated, Purchase, NY (US)

(21) Appl. No.: 14/244,228

(22) Filed: Apr. 3, 2014

(51) Int. Cl. G06Q 20/40; G06Q 20/38; G06Q 20/34

(52) U.S. Cl. CPC G06Q 20/401; G06Q 20/342; G06Q 20/385

(57) ABSTRACT

Systems, apparatus and methods for cost effectively and accurately testing the validity and/or success of an over-the-air (OTA) personalization of a payment-enabled mobile device. In an embodiment, a process includes transmitting, by a mobile device processor to an issuer financial institution (FI) computer, a request for a unique number, receiving the unique number, generating a cryptogram based on the unique number, and transmitting the cryptogram and a zero value purchase amount transaction request to the issuer FI computer. The process also includes receiving, by the mobile device processor, a zero value transaction authorization message from the issuer FI computer which indicates that the payment application successfully loaded and is functional. In some embodiments, a payment application load success message is then displayed on a display component of the payment-enabled mobile device.

### FIELD OF THE DISCLOSURE

In general, over the air (OTA) methods and apparatus are described for testing and/or ensuring that a payment application personalized onto a payment-enabled mobile device was correctly or successfully loaded and is functional. In an embodiment, an application on a user's payment-enabled mobile device detects completion of an OTA personalization process, requests an unique number from an issuer financial institution (FI) computer, and after receiving the unique number transmits a cryptogram and a zero value purchase amount transaction request to the issuer FI computer. Authorization of the zero purchase amount transaction by the issuer FI computer indicates that personalization was successful and that the payment application is functional.

### BACKGROUND

Payment cards such as credit cards, debit cards and/or gift cards are ubiquitous and have been used by consumers for decades. Such cards typically include a magnetic stripe on which the relevant account number and other data is stored. To consummate a purchase transaction with such a card, the card is swiped through a magnetic stripe reader that is part of a point-of-sale (POS) terminal. The reader reads the account number and other data from the magnetic stripe. The account number is then used to route a transaction authorization request that is initiated by the POS terminal. The authorization request is typically routed from the merchant's acquiring financial institution (“acquirer”) to a server computer operated by or on behalf of the issuer of the payment account, and the issuer's server computer provides a response. If the authorization response indicates that the issuer has authorized the transaction, the transaction is consummated at the POS terminal. The transaction is later cleared for settlement via the acquirer and the issuer.

Payment cards have been developed that allow the account number to be automatically read from the card by radio frequency communication between the card and a “proximity reader” which may be incorporated with the POS terminal. Such cards are often referred to as “proximity payment cards” or “contactless payment cards”, and conventionally include a radio frequency identification (RFID) integrated circuit (IC, often referred to as a “chip”) embedded in the card body. A suitable antenna is also embedded in the card body and is connected to the RFID chip to allow the chip to receive and transmit data by RF communication via the antenna. In typical arrangements, the RFID chip is powered from an interrogation signal that is transmitted by the proximity reader and received by the card antenna. In some embodiments, the payment card account number and other information may be uploaded from the IC payment card to the POS terminal during a purchase transaction. Authorization and clearing may then proceed in substantially the same manner as for a transaction initiated with a magnetic stripe payment card (putting aside additional security measures that may be implemented by using the processing capabilities of the IC payment card). An example of a contactless payment card standard is the “PayPass™” payment card system established by MasterCard International Incorporated, the assignee hereof.

The capabilities of a contactless payment card have been incorporated into a mobile device, such as a mobile telephone, which turns the mobile device into a contactless payment device or payment-enabled mobile device. A payment card account number and other account or device-specific information is loaded into the mobile device by a process typically referred to as “personalization”. Since mobile devices, such as mobile telephones, come in many sizes and shapes (and use different operating systems), these mobile devices cannot be readily subjected to the same kind of automated personalization process that contactless payment cards typically undergo. In the case of mobile telephones, logistical problems also arise concerning transporting a mobile telephone/contactless payment device to a personalization facility either after the user has purchased the mobile telephone, or before placing the cell phone in a typical mobile telephone distribution channel. Thus, for mobile telephone/contactless payment devices that are already in a distribution channel and/or already in the user's possession, in some markets remote or “over the air” (OTA) data communications are utilized to personalize the mobile telephone/contactless payment card device by data communication via the mobile telephone network in which the phone operates.

The inventors recognized that a need exists for a simple, cost effective and accurate process to test the validity and/or success of a remote or OTA personalization of a user's payment-enabled mobile device. Moreover, a need exists for a reliable process to test the validity of a payment application upgrade process to ensure that it was successful and is functional before deleting a previously loaded (and functional) payment application from the user's payment-enabled mobile device. In addition, the inventors recognized that, unlike for a conventional payment card having a magnetic stripe or even for a contactless payment card housing proximity circuitry, it is not practical to provide a replacement mobile device (such as a new cell phone) to a consumer because of a reported problem concerning the payment functionality of the cardholder's current mobile device. Thus, systems and/or processes to facilitate the investigation and resolution of such mobile device payment functionality problems while the device is still with the cardholder would be desirable.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a simplified block diagram schematically illustrating a personalization process involving a payment-enabled mobile device;

FIG. 2 is a block diagram of a conventional payment system including a payment-enabled mobile telephone that has been personalized to function as a contactless payment device;

FIG. 3 is a block diagram that illustrates an example embodiment of a payment-enabled mobile telephone as shown in FIGS. 1 and 2;

FIG. 4 is a block diagram that schematically illustrates some software aspects of the payment-enabled mobile telephone of FIGS. 1-3 in accordance with some embodiments of the disclosure;

FIG. 5 is a block diagram of an embodiment of a personalization system to illustrate a provisioning process pursuant to some embodiments according to the disclosure;

FIG. 6 is a flowchart illustrating an embodiment of payment application personalization and automatic testing process according to the disclosure;

FIG. 7 is a flowchart illustrating an embodiment of payment application personalization and semi-automatic testing process according to the disclosure; and

FIG. 8 is a flowchart illustrating an embodiment of payment application personalization and customer care testing process according to the disclosure.

### DETAILED DESCRIPTION

The capabilities of a contactless payment card have been incorporated into a mobile device, such as a mobile telephone, which turns the mobile device into a contactless payment device or payment-enabled mobile device. A payment card account number and other account or device-specific information is loaded into the mobile device by a process referred to as “personalization”. Persons skilled in the art understand that “personalization” refers to the process by which consumer or user- and/or account-specific information is loaded into and/or otherwise applied to a payment device such as a contactless payment card and/or other types of contactless payment devices in other form factors. Examples of contactless payment devices may include, but are not limited to mobile telephones, personal digital assistants (PDAs), digital music players, laptop computers and tablet computers that include mobile communication capabilities and/or incorporate contactless payment functionality. Examples of alternate types of form factors that may incorporate IC payment circuitry configured for making contactless payments may include, but are not limited to key fobs, wristwatches, wristbands, and stickers. Since mobile devices, such as mobile telephones, tablet computers, digital music players and the like can come in many sizes and shapes (and use different operating systems), the automated personalization process that contactless payment cards typically undergo cannot be utilized. For example, in the case of mobile telephones, logistical problems arise concerning transporting the mobile telephone (or contactless device) to a personalization facility either after the user or consumer has purchased that mobile telephone, or before placing the mobile telephone in a typical mobile telephone distribution channel. Thus, for payment-enabled mobile telephones that are already in a distribution channel and/or are already in the users' possession, in some markets “over the air” (OTA) data communications are utilized to personalize the payment-enabled mobile telephone. In particular, OTA data communications may occur between the consumer's payment-enabled mobile telephone via a mobile telephone network (operated by the consumer's mobile network operator (MNO)) and the payment card issuer financial institution (FI) to facilitate OTA personalization.

In general, and for the purpose of introducing concepts of embodiments of the present disclosure, presented herein are OTA methods and systems for testing and/or ensuring that a payment application personalized onto a payment-enabled mobile device was correctly or successfully loaded and is functional. In particular, when a contactless payment application is downloaded and personalized onto a secure element of a payment-enabled mobile device via an OTA personalization process, the success of the OTA personalization is tested and/or validated by analyzing the feedback from each individual command or application protocol data unit (APDU) transmitted to the secure element. In some implementations, if the secure element responds with an error message during personalization, the user may be notified and/or prompted to retry the process and/or to contact his or her MNO or issuer FI to troubleshoot the OTA personalization process. However, even if the secure element fails to respond with an error message during personalization, it is still possible that the payment-enabled mobile device, such as a payment-enabled mobile telephone, is not operational or functional (i.e., it cannot successfully complete a payment transaction). In such cases, the consumer may not be aware of the fact that the payment application loaded onto his or her payment-enabled mobile telephone is not operational. In fact, the consumer may only become aware of a problem when attempting to purchase goods and/or services, for example, from a merchant at a merchant's retail store. When the purchase attempt fails, the result may be consumer embarrassment and/or frustration, which may also cause the loss of that customer by the MNO and/or by the issuer FI responsible for provisioning a functional payment application onto the consumer's mobile device. This problem may occur when the payment-enabled mobile device is first personalized via an OTA process, and/or when a payment application stored on a secure element of the mobile device (of an otherwise functional payment-enabled mobile device) is upgraded (either at the behest of an issuer FI or resulting from a request by the consumer).

Accordingly, presented herein are systems, apparatus and methods for easily, cost effectively, and accurately testing the validity and/or success of a remote or OTA personalization of a user's payment-enabled mobile device. In particular, processes disclosed herein operate to verify that loading of a payment application has completed, and to test to ensure that the payment application is functioning correctly. The systems and processes disclosed herein also can reliably test the validity of a payment application upgrade process to ensure that it was successfully loaded and is functional before a previously loaded (and functional or usable) payment application is deleted from a secure element of the user's payment-enabled mobile device. Yet further, systems and processes disclosed herein operate to detect errors and/or problems concerning the payment application loading process and/or payment application functionality during the personalization process, and in some cases can resolve such errors and/or problems automatically without the user even being aware of a problem or issue. Accordingly, such systems and/or processes facilitate the investigation and resolution of mobile device payment functionality problems while the device is still with the cardholder. Such operation saves costs for mobile device network operators (MNOs) and/or payment processors (such as MasterCard International Incorporated, the assignee hereof), for example, because these entities can avoid the expense of providing a replacement mobile device (such as a new cell phone) to a consumer or user due to reported problems concerning the payment functionality of a user's or cardholder's current mobile device that could have been diagnosed and/or repaired or fixed remotely.

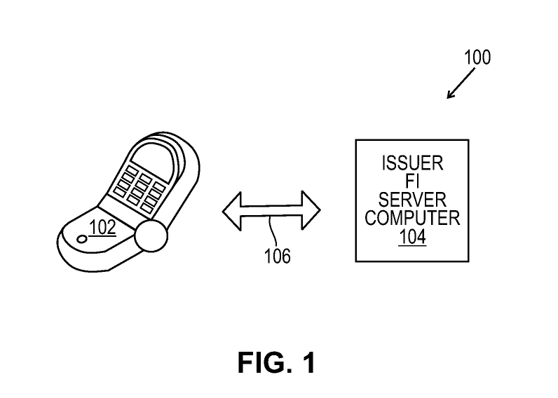

FIG. 1 is a simplified block diagram 100 schematically illustrating personalization of a payment-enabled mobile device, such as a mobile telephone 102, so that a user can make contactless purchase transactions. An issuer financial institution (FI) server computer 104 is operated by or on-behalf of an issuer FI of payment card accounts. The payment card issuer FI server computer 104 is the source of information that is loaded into the payment-enabled mobile telephone 102 for the purpose of personalizing a secure element of an integrated circuit (IC) (not shown) of the payment-enabled mobile telephone 102. The Arrow 106 schematically illustrates a communication channel by which the personalization information is transmitted from the payment card issuer server computer 104 to the payment-enabled mobile telephone 102, which also may be utilized for transmitting feedback information concerning progress of the personalization process (for example, error messages) from the payment-enabled mobile telephone 102 to the issuer FI server computer 104. The communication channel 106 may also be used to exchange other forms of data or information as discussed herein.

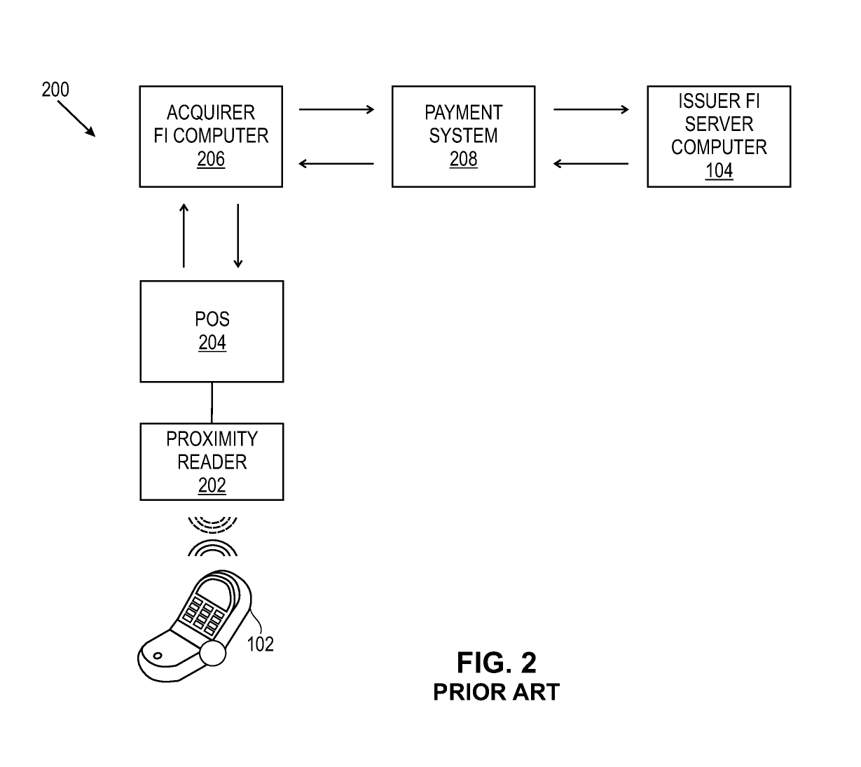

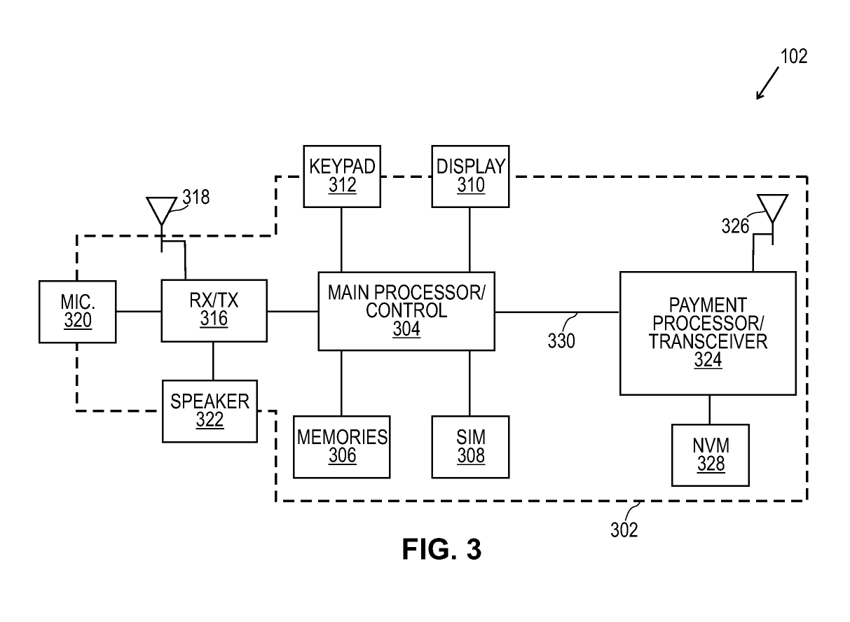

FIG. 2 is a block diagram of a conventional payment system 200 that includes a payment-enabled mobile telephone 102 that has been personalized to include a payment application. The payment-enabled mobile telephone 102 may be operable as a mobile telephone, while also being able to perform functions of a contactless payment card. Further details of the payment-enabled mobile telephone 102 are described below in conjunction with FIG. 3.

The system 200 further includes a proximity reader component 202 associated with a point of sale (POS) terminal 204. The proximity reader component 202 and the POS terminal 204 may be substantially or entirely conventional in their hardware aspects and may also incorporate conventional software capabilities. The proximity reader component 202 and the POS terminal 204 may be located, for example, at the premises of a retail store and may be operated by a sales associate or cashier employed by a retailer for the purpose of processing retail purchase transactions. The payment-enabled mobile telephone 102 is shown interacting with the proximity reader component 202 in a contactless or wireless manner for the purpose of executing such a purchase transaction. Such a wireless communication may be conducted in accordance with one or more standard protocols, such as the “EMV Contactless” and/or the near field communication (NFC) protocols, which are known to those skilled in the art. However, in some embodiments, in order to communicate with the proximity reader component 202, it may be required to physically tap the payment-enabled mobile device 102 onto a portion of the proximity reader component. For example, to initiate wireless communications, the user of the payment-enabled mobile telephone 102 may be required to briefly tap the payment-enabled mobile telephone at a particular location on the proximity reader component 202. In some embodiments, the location on the proximity reader component 202 at which the payment-enabled mobile telephone 102 is to be tapped may be indicated to the user by a standard logo and/or sticker affixed to the proximity reader component 104.

An Acquirer financial institution (FI) computer 206 operated by, for example, an acquirer bank associated with the merchant is also shown as part of the system 200 of FIG. 2. The acquirer FI computer 206 may operate in a conventional manner to receive an authorization request for the purchase transaction from the POS terminal 204, and may route the authorization request via a payment system 208 to the issuer FI server computer 104 (operated by the issuer FI of the payment card account that is available for access by the payment-enabled mobile telephone 102). The authorization response generated by the payment card issuer FI server computer 104 may be routed back to the POS terminal 204 via the payment system 208 and the acquirer FI computer 206. In some embodiments, the payment system 208 may be entirely or substantially conventional, and an example of a suitable payment system is the well-known Banknet™ system operated by MasterCard International Incorporated, the assignee hereof. Thus, the payment card issuer server computer 208 may be operated by or on behalf of a financial institution that issues payment card accounts to individual users. In many respects, the payment card issuer server computer 208 may perform conventional functions, such as receiving and responding to requests for authorization of payment card account transactions to be charged to payment card accounts issued by the FI, and tracking and storing transactions and maintaining account records.

It should be understood that the components shown in the system 200 of FIG. 2 are only those that are needed for processing a single purchase transaction. One skilled in the art will recognize that a practical embodiment of the system 200 may be configured for processing many purchase transactions (including simultaneous transactions) and may include a considerable number of payment card issuers FIs and their computers, a considerable number of acquirer FIs and their computers, and numerous merchants and their POS terminals and associated proximity reader components. The system may also include a very large number of payment card account holders, who may carry different types of payment-enabled mobile devices and/or IC payment cards.

It should also be understood that the payment-enabled mobile telephone 102 is operable as a conventional mobile telephone for communication—both voice and data—over a conventional mobile telecommunications network, which is not depicted in FIG. 2. Thus, the payment-enabled mobile telephone 102 is in communication in a conventional manner with a mobile network operator (MNO) (not shown). An OTA communication channel (not shown in FIG. 2) between the payment-enabled mobile telephone 102 and the payment card issuer FI server computer 104 (or a related computer) may be established from time to time for various purposes, which may include personalization of the payment application program in the payment-enabled mobile telephone 102; updates to the personalization; loading and/or reloading pre-paid and/or pre-authorized funds in connection with the payment application program; and/or resetting a counter or accumulator established in the payment-enabled mobile telephone 102 for risk management purposes.

FIG. 3 is a block diagram representation of an embodiment of a payment-enabled mobile telephone 102 in accordance with aspects of the disclosure. The payment-enabled mobile telephone 102 may be conventional in its hardware aspects. For example, the payment-enabled mobile telephone 102 may resemble, in most of its hardware aspects and many of its functions, any number of typical or conventional “smart phones” currently on the market.

The payment-enabled mobile telephone 102 may include a conventional housing (indicated by dashed line 302 in FIG. 3) that contains and/or supports the other components of the payment-enabled mobile telephone 102. The housing 302 may be shaped and sized to be held in a user's hand, and may for example fit in the palm of the user's hand. The payment-enabled mobile telephone 102 further includes conventional control circuitry 304, for controlling over-all operation of the payment-enabled mobile telephone 102. For example, the control circuitry 304 may include one or more conventional low-power processors.

Other components of the payment-enabled mobile telephone 102, which are in communication with and/or controlled by the control circuitry 304, include one or more memory devices 306 (for example, program and working memory), a conventional SIM (subscriber identification module) card 308, a keypad 312 for receiving user input, and a conventional display component 310 (which may be a touch screen) for displaying output information to the user. The keypad 312 may include, for example, a conventional 12-key telephone keypad, in addition to other buttons, switches and keys, such as a conventional rocker-switch/select key combination, soft keys, and send and end keys. As is now frequently the case with smart phones, the functionality represented by the display 310 and keypad 312 may be provided in an integrated manner via a conventional touch screen display, which is not indicated in the drawing apart from blocks 310 and 312.

The payment-enabled mobile telephone 102 also includes conventional receive/transmit circuitry 316 that is also in communication with and/or controlled by the control circuitry 304. The receive/transmit circuitry 316 is coupled to an antenna 318 and provides the communication channel(s) by which the payment-enabled mobile telephone 102 communicates via the mobile telephone communication network or MNO (not shown). The receive/transmit circuitry 316 may operate both to receive and transmit voice signals, in addition to performing data communication functions.

The payment-enabled mobile telephone 102 further includes a conventional microphone 320 operably connected to the receive/transmit circuitry 316, which is utilized to receive voice input from the user. A speaker 322 provides sound output to the user, and is also operably coupled to the receive/transmit circuitry 316.

In conventional fashion, the receive/transmit circuitry 316 operates to transmit, via the antenna 318, voice signals generated by the microphone 320, and operates to reproduce, via the loudspeaker 322, voice signals received via the antenna 318. The receive/transmit circuitry 316 may also handle transmission and reception of text messages (which may be SMS messages) and other data communications via the antenna 318.

The payment-enabled mobile telephone 102 may also include a payment circuit 324 and a loop antenna 326 that is operably coupled to the payment circuit 324. The payment circuit 324 may include components that function to allow the payment-enabled mobile telephone 102 to operate as a contactless payment device. In some embodiments, the payment circuit 324 includes one or more processors (not separately shown) and a memory (not separately shown) that is coupled to the processor(s) and that stores program instructions for controlling the processor(s). The payment circuit 324 is in communication with the control circuitry 304 via a data communication connection 330. But in some embodiments, the payment circuitry 324 and/or its processor(s) may be integrated with the main processor 304. Thus, in some implementations the functionality represented by the payment circuit 324 may be largely implemented with a payment application program (not shown in FIG. 3) that controls a portion of the operations or functionality of the main processor 304. The control aspect of the payment circuitry 324 may also control a transceiver (also represented by block 324) which handles the short-distance wireless communications (such as NFC communications) via the antenna 326. In accordance with conventional practices and some embodiments, the payment-enabled mobile telephone 102 may include a “secure element” (not separately shown), which may be incorporated with the payment circuit 324, the main processor 304 or the SIM card 308. Those skilled in the art know that such a secure element may include a small processor (e.g., a microprocessor) and volatile and/or nonvolatile memory such as the non-volatile memory (NVM) 328 which is secured from tampering and/or unauthorized reprogramming by utilization of suitable security measures. The secure element may, for example, manage functions such as storage of the consumer's payment card account number, providing access to the payment card account number during a purchase transaction, and cryptographic processing. In addition, the secure element may store counter values and/or accumulator values that the payment-enabled mobile telephone 102 uses with respect to risk management activities.

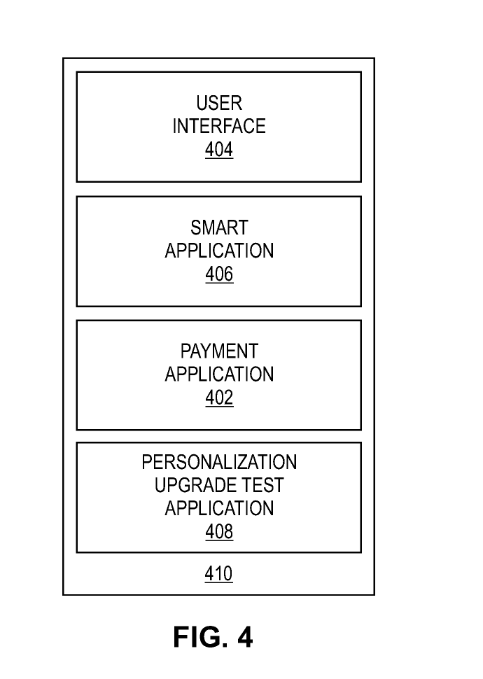

FIG. 4 is a block diagram that schematically illustrates some software aspects of the payment-enabled mobile telephone 102. In some embodiments, a payment application 402 may be operable in a payment mode and in a management mode. The payment application may operate in the payment mode when the payment-enabled mobile telephone is engaged in an exchange of communications with a proximity reader component 202 (see FIG. 2) during a purchase transaction, and otherwise may be operable in the management mode. The payment application may operate in the management mode, for example, when the payment application is being configured, or when the payment application is accepting input from the user (for example, input for cardholder verification), or when the payment application is being tested to ensure successful personalization and/or to ensure a successful upgrade. In particular, the payment application 402 may be conventional in some aspects, but in other respects it may include instructions configured to cause the payment-enabled mobile telephone control circuitry to implement testing or validation of a personalization process and/or an upgrade process as described herein.

Referring again to FIG. 4, user interface software 404 may control a portion of the operations of the main processor 304 (shown in FIG. 3). For example, the user interface software 404 may receive input from, and control displaying of information on, a touch screen 310 referred to above in conjunction with FIG. 3. The payment application program 402 and the user interface software 404 may interact with each other to allow the user or consumer or cardholder to control and/or respond to the payment functionality of the payment-enabled mobile telephone 102. The interaction between the payment application program 402 and the user interface software 404 may be mediated by a software program that may be referred to as a “smart application” 406. The smart application 406 may interact with the user through the user interface (for example, a touch screen display or a keyboard) via the user interface software 404 to receive input such as acknowledgement (ACK) signals and/or personal identification number (PIN) entry and/or other cardholder verification method (CVM) entry (which may include the use of biometric information, such as a fingerprint, iris scan, audio indicator, and the like). The smart application 406 may also instruct the payment application program 402 as to how the payment application program is to be configured in a management mode of the payment application program. Such instructions from the smart application 406 to the payment application program 402 may be based on information received by the smart application 406 via OTA communications from the issuer FI server computer 104. In addition, a personalization and/or upgrade test application 408 may be included that functions to first detect or determine when a personalization process and/or an upgrade of the payment application has completed, and then to request a unique number from the issuer FI server computer. When the unique number is received, the personalization and upgrade test application 408 may generate a cryptogram and a zero sum purchase transaction request (which is a purchase transaction request that has a value of zero), and then transmit both to the payment card issuer FI server computer to test the functionality of the payment application, which will be described in more detail below. Thus, the smart application 406 may operate in conjunction with the personalization and/or upgrade test application 408 to communicate and interact with the payment card account issuer FI server computer 104 (see FIGS. 1 and 2) via an over-the-air (OTA) interface for purposes of testing the success and/or the validity of a personalization process (or of an upgrade process) to the payment application 402.

The payment application program 402, the user interface software 404, the smart application 406 and the personalization and/or upgrade test application 408 may each be stored in one or more of the memory devices referred to above in conjunction with FIG. 3, and such memory devices are collectively represented by the storage device 410 of FIG. 4. The storage device 410 is a non-transitory computer readable medium and/or any form of computer readable media capable of storing computer instructions and/or application programs and/or data. It should be understood that non-transitory computer-readable media comprise all computer-readable media, with the sole exception being a transitory, propagating signal.

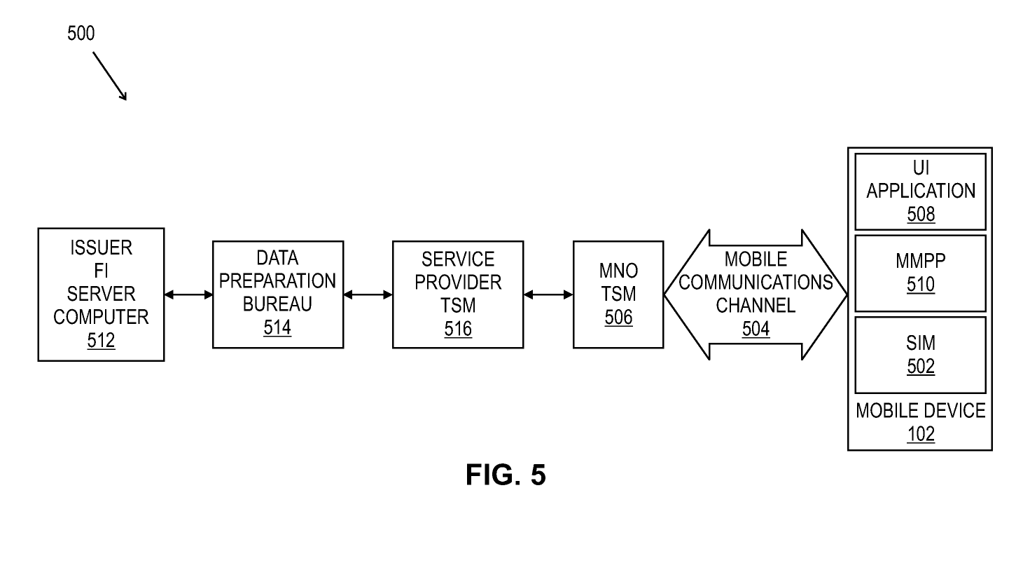

FIG. 5 is a block diagram of an embodiment of a personalization system 500 to illustrate a provisioning process pursuant to some embodiments. The components shown in FIG. 5 are configured to implement a “push” method of provisioning, in which provisioning is performed using a mobile communications channel 504, and in some implementations the mobile communications channel may be a Bearer Independent Protocol (BIP) channel. It should be understood, however, that other forms of provisioning methods (such as a “pull” method) and/or other types of communications channels could be utilized. The “push” process is performed from a mobile network operator (MNO) trusted service manager (TSM) 506 computer to a specific secure element (depicted as a subscriber identification module (SIM) 502) associated with the consumer's payment-enabled mobile device 102 via the mobile communications channel 504. In some embodiments, the mobile device 102 includes a user interface (UI) application 508 and a MasterCard Mobile PayPass (MMPP) application 510. In such embodiments, a further provisioning message may subsequently be transmitted to the payment-enabled mobile device 102 for display to the consumer to confirm that provisioning was successful.

In some embodiments, the mobile communications channel is a mechanism by which a mobile phone provides a (U)SIM with access to the data bearers supported by the payment-enabled mobile device (for example, Bluetooth, IrDA, and the like) and the mobile network (for example, GPRS, 3G, and the like). The SIM card 502 is used to communicate on GSM-type networks, whereas a USIM is a micro-computer which is able to handle several applications, such as a contactless electronic payment application. A high performance mobile communications channel can deliver broadband-like data speeds to the USIM, which enables mobile network operators (MNOs) to deliver revenue generating services faster, more effectively, and with higher reliability than via an SMS channel. Such a high performance mobile communications channel also allows (U)SIM cards to download data through a mobile devices' high speed data channel (like GPRS and 3G) onto the (U)SIM. For example, services like remote file management (RFM) and/or remote application management (RAM) will run significantly faster as compared to a conventional communications channel, and are thus ideally suited for performing administrative operations, such as loading and/or updating applications on the (U)SIM of a payment-enabled mobile device.

Referring again to FIG. 5, to initiate a personalization of the payment-enabled mobile device 102, the payment card issuer FI server computer 512 transmits an OTA provisioning request to a data preparation bureau 514. The data preparation bureau 514 is an entity or service provider that performs aggregation of card holder personalization data from the Issuer FI server computer 512 of all cardholders who are registered with that particular issuer FI. Thus, the provisioning request for a particular payment-enabled mobile device includes the customer's data (including payment card account information, the telephone number of the mobile device, and the like), which was obtained during a service subscription process (not described herein). The data preparation bureau 514 may then transmit a key derivation request (such as, for example, an EMV key derivation request message) to a service provider trusted service manager (SP TSM) computer 516, which may be associated with the issuer FI (of the consumer's payment card account) to initiate EMV data preparation processing. The data preparation bureau computer 514 also transmits an OTA provisioning request message to the SP TSM 516 with the EMV personalization data.

In some embodiments, the SP TSM 516 also interacts with the customer or end user via the payment-enabled mobile device 102 to perform activation or verification code processing. In such cases, the customer may be prompted to enter an activation code or a verification code into the mobile device 102 which then transmits the activation code or verification code to the SP TSM 516 via the MNO 506. (The activation code or verification code may have been provided by the issuer FI to the cardholder via another communications channel, for example, via the internet in the form of an e-mail to an e-mail account of the cardholder.) In such implementations, after verifying the activation code or verification code the SP TSM 516 transmits a MMPP provisioning load/installation request message via the BIP channel 504 to the secure element (the SIM 502) of the payment-enabled mobile device 102. The SP TSM 516 then performs MMPP personalization via the BIP, and in some embodiments, the SP TSM transmits a push notification for MasterCards' Mobile PayPass user interface (MMPP UI) download from a third party application server (which may be via SMS with a uniform resource locator (URL)) to the mobile device 102. As mentioned earlier, when a contactless payment application is downloaded and personalized onto the secure element via an OTA personalization process, feedback from each individual command or application protocol data unit (APDU) transmitted to the secure element is analyzed by the issuer FI server computer 512 to test and/or validate the success of the OTA personalization. In some implementations, if the secure element responds with an error message during personalization, the user may be prompted to retry the process and/or to contact his or her MNO to troubleshoot the OTA personalization process. However, as mentioned earlier, it is possible that no error messages occurred during personalization and yet the payment-enabled mobile device 102 is still not operational or functional as a contactless payment device (i.e., it cannot successfully complete a payment transaction).

After the personalization process has completed, the customer interacts with the payment-enabled mobile device 102 to transmit registration information to the SP TSM 516 with activation data. In some embodiments, the SP TSM 516 then transmits a MMPP UI binding request which allows an application installed on the payment-enabled mobile device 102 to communicate with an application inside the SIM 502. In some embodiments, the application on the payment-enabled mobile device 102 is a graphical user interface (GUI) which communicates with the MMPP (the application inside the SIM 502), which are thus bound once the process executes. In this case, an MMPP UI binding request is transmitted to the SIM 502 to provision the payment-enabled mobile device 102.

Once the push personalization processing is completed in accordance with the above example, under normal circumstances the mobile device 102 and the SIM 502 (the secure element) will have been personalized with PayPass application data and payment information. The SP TSM 516 completes the process by transmitting a status change notification message to the MNO TSM 506 (signifying the successful completion of personalization processing), and the payment-enabled mobile device 102 should then be able for use to conduct NFC payment transactions. However, as explained above, it is still possible that the payment-enabled mobile device 102 cannot successfully complete a payment transaction due to a failure in the personalization process that did not trigger an error message. For example, a hardware failure, such as a transceiver circuit failure, during the personalization process may not cause an error message to be transmitted during personalization but may cause the payment-enabled mobile telephone 102 may to be non-operational as a payment device. In another example, an error message may not have been transmitted during personalization because the device may have had a low battery or was outside the coverage area.

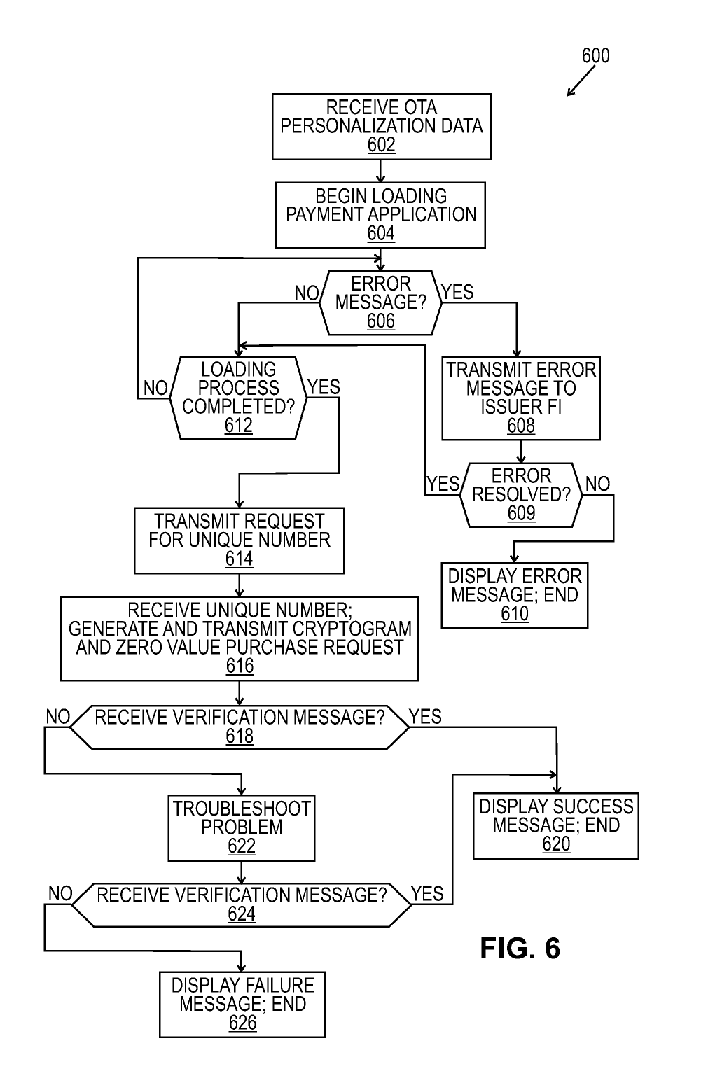

It has been recognized that, in order to ensure that the payment application has been successfully personalized onto the payment-enabled mobile device (or successfully upgraded) so as to be functional, it is necessary to perform a payment transaction. Accordingly, FIG. 6 is a flowchart 600 illustrating a payment application personalization and automatic testing process according to some embodiments. A payment-enabled mobile device receives 602 OTA personalization data, and then begins loading 604 the payment application into a secure element. In some implementations, as the loading process progresses feedback from each individual command or application protocol data unit (APDU) is analyzed, and if a problem is detected then in step 606 an error message is generated, and the error message is transmitted 608 to the issuer FI. When an error is detected during loading of the payment application, in some embodiments the system may make one or more additional attempts to correctly load the payment application or to otherwise resolve the problem. For example, the payment-enabled mobile device may be operable to communicate OTA with an issuer FI server computer to troubleshoot the problem and/or to automatically fix the problem. However, if in step 609 the system cannot resolve the problem, then a warning message or an error message may be displayed 610 on a display component of the user's payment-enabled mobile device so that the user is made aware that the personalization process failed such that the payment-enabled mobile device cannot be used as a payment device, and the process ends. In some embodiments, instructions may also be displayed and/or otherwise provided to the user regarding how best to proceed. For example, the system may notify or prompt the cardholder or user via SMS message or e-mail message to retry the process, and/or to contact a customer care representative of his or her MNO, and/or to contact a representative of the issuer FI to troubleshoot the OTA personalization process.

Referring again to FIG. 6, if no error messages are detected in step 606, then in some embodiments a personalization and/or upgrade test application checks to see if loading of the personalized payment application has completed 612. If not, the process loops back to step 606 wherein another check for any error messages occurs. But if it is determined in step 612 that the personalized payment application loading process has completed, then in some embodiments the mobile device transmits 614 a request for a unique number to an issuer FI server computer. The issuer FI may utilize, for example a random number generator or another means or process to generate a unique number, and then transmits the unique number to the user's payment-enabled mobile device. After the user's payment-enabled mobile device receives the unique number, in some implementations the personalization and/or upgrade test application generates a cryptogram based on the unique number, and then transmits 616 the cryptogram and a zero value purchase request to the issuer FI computer. If the cryptogram received from the user's payment-enabled mobile device is valid, then the issuer FI computer then may perform a conventional purchase transaction authorization process using the zero value purchase transaction data. If the issuer FI computer is able to validate and/or authorize the zero-value purchase transaction, then the issuer FI transmits a purchase transaction authorization message or verification message back to the mobile device. Accordingly, if such a purchase transaction authorization message or verification message is received 618 by the user's payment-enabled mobile device (for example, within a predetermined amount of time after transmitting the cryptogram) then, in some embodiments, the personalization and/or upgrade test application generates a success message that is displayed 620 on a display component of the user's payment-enabled mobile device so that the user can be confident that his or her payment-enabled mobile device will function correctly as a contactless payment device.

The payment application personalization and automatic testing process 600 may also be utilized by a personalization and/or upgrade test application when a current payment application on the user's payment-enabled mobile device undergoes an upgrade process. In this case, an upgraded payment application is loaded onto the secure element of the user's payment-enabled mobile device and the back level payment application is initially left on the secure element. In accordance with the processing described above, after the issuer FI server computer successfully processes a zero sum purchase transaction, the issuer FI server computer may, in some embodiments, transmit instructions to the cardholder's payment-enabled mobile device to delete the back-level payment application. Such processing ensures that the back level payment application is not deleted until and/or unless the upgraded payment application has successfully been loaded on the user's payment-enabled mobile device and has been tested to ensure that it functions correctly.

Referring again to FIG. 6, if in step 618 a purchase transaction authorization message or a verification message has not been received within a predetermined amount of time by the user's payment-enabled mobile device, then in some implementations the system automatically attempts to troubleshoot 622 the problem. For example, the personalization/upgrade test application may obtain data from one or more usage logs of the payment-enabled mobile device, for example, data from an NFC field log (which may indicate the number of times near field communications (NFC) occurred, and/or when the last NFC communication occurred), and then communicate or report such data OTA to an MNO computer and/or to an issuer FI server computer. Such data may be utilized by the MNO computer and/or by the issuer FI server computer to remotely troubleshoot and/or remotely debug the problem and/or automatically fix the problem. For example, the data from a mobile device usage log may indicate that it is the first time an attempt is being made to load a payment application into this mobile device, but the NFC field log indicates that other NFC applications of the mobile device have been working correctly and that an NFC application operated correctly yesterday evening at 9:30 pm. In this case, it may be assumed that the NFC circuitry is working correctly, and then attention is focused on other issues and/or other mobile device circuitry that may be causing the problem. If a problem is found then a solution may be found and applied by, for example, an MNO computer downloading software code top the mobile device that includes instructions which fixes the problem. In some embodiments, the mobile device itself may include one or more self-diagnostic programs or software code which can be utilized to pinpoint problems and provide solutions. In either case, if the problem appears to be solved, then in some embodiments the personalization and/or upgrade test application will again generate a cryptogram based on the unique number and transmits the cryptogram and a zero value purchase request to the issuer FI computer. If the cryptogram is deemed valid by the issuer FI, then the issuer FI computer performs a conventional purchase transaction authorization process using the zero value purchase transaction data. If the issuer FI computer is able to validate and/or authorize the zero-value purchase transaction, then the issuer FI transmits a purchase transaction authorization message or verification message back to the mobile device. When the verification message is received 624, then a success message is displayed 620 on the mobile device display screen so that the user knows that the mobile device can now be used as a payment device. In this scenario, the user or mobile device owner may never have been made aware of any problems with regard to the loading and/or functionality of the payment application. However, if in step 624 the verification message is not received within a second predetermined period of time, then the personalization and/or upgrade test application may cause the mobile device to display 626 of a failure message on the display component.

It should be understood that, in some embodiments the troubleshooting step 622 may involve multiple tries at correcting or fixing the problem, which may take milliseconds up to several seconds or more in real time to try. In such cases, the use of mobile device usage logs, such as the NFC field log, play an important role when trying to remotely resolve an NFC problem. In particular, an issuer FI server computer may use data in one or more NFC usage logs (such as the NFC field log) to determine one or more actions to take, which may include downloading instructions and/or computer code to fix the problem and/or error. In addition, when an NFC issue cannot be resolved remotely, the failure message may include instructions for the cardholder or user to retry the entire personalization process from the beginning, and/or to contact a customer care representative of his or her MNO, and/or to contact a representative of the issuer FI to troubleshoot the OTA personalization process.

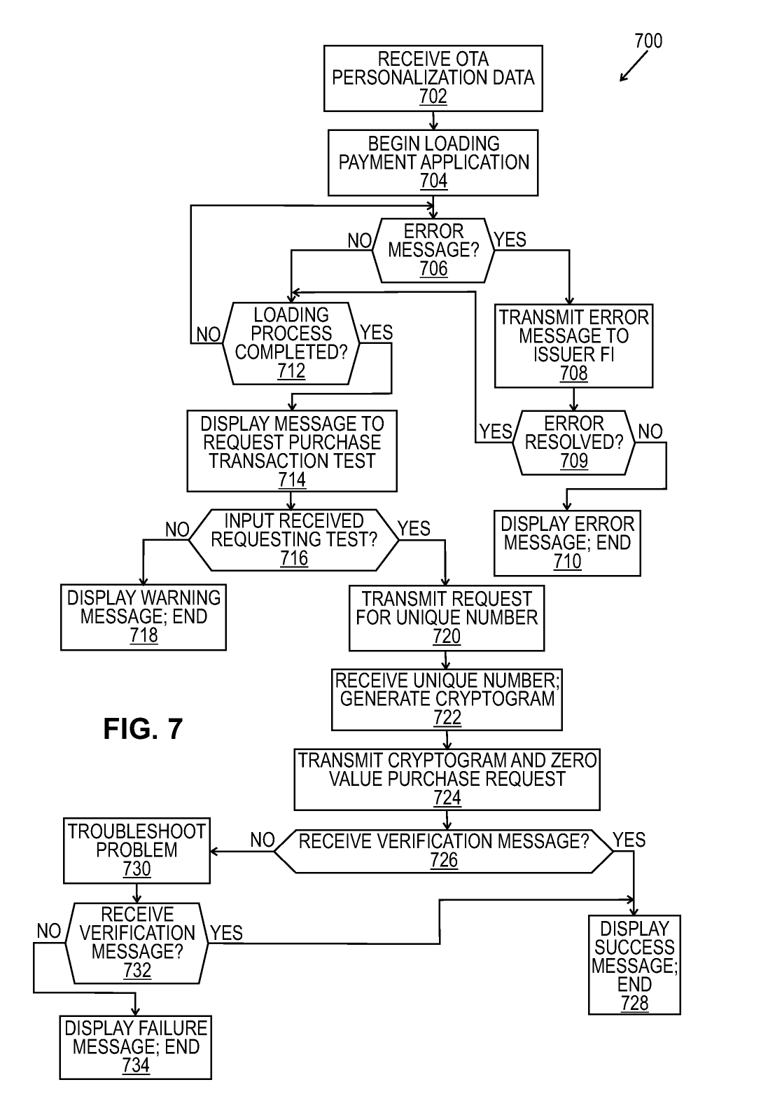

FIG. 7 is a flowchart 700 illustrating a payment application personalization and semi-automatic testing process according to an embodiment. A payment-enabled mobile device receives 702 OTA personalization data, and begins loading the 704 the payment application onto a secure element of the user's payment-enabled mobile device. In some implementations, as loading progresses feedback from each individual command or application protocol data unit (APDU) is analyzed, and if a problem is detected then in step 706 an error message is generated, and the error message is transmitted 708 to the issuer FI computer. When an error is detected during loading of the payment application, in some embodiments the system may make one or more additional attempts to correctly load the payment application or to otherwise resolve the problem. For example, the payment-enabled mobile device may be operable to communicate OTA with an issuer FI server computer to troubleshoot the problem and/or to automatically fix the problem. However, if in step 709 the system cannot resolve the problem, then an error message may be displayed 710 on a display component of the user's payment-enabled mobile device so that the user is made aware that the personalization process failed such that the payment-enabled mobile device cannot be used as a payment device, and the process ends. In some embodiments, instructions may also be provided to the user regarding how best to proceed. For example, depending on how and/or which portion of the personalization process caused an error, the cardholder or user may be notified and/or prompted to retry the personalization process, and/or to contact a customer care representative of his or her MNO, and/or to contact the issuer FI to troubleshoot the OTA personalization process.

Referring again to FIG. 7, if there are no error messages in step 706, then in some embodiments a personalization and/or upgrade test application may check to see if loading of the personalized payment application has completed 712. If not, the process loops back to step 706 wherein another check for any error messages occurs. But if it is found in step 712 that the personalized payment application loading process has completed, then in some embodiments the personalization and/or upgrade test application causes a display component of the user's payment-enabled mobile device to display 714 a message to the user or cardholder to request a purchase transaction test. For example, the user may be instructed to go online and visit a website associated with the issuer FI server computer and enter information before a zero value purchase transaction can be generated and transmitted from the user's payment-enabled mobile device. If the user's payment-enabled mobile device does not receive 716 user input concerning the test request from the user within a predetermined period of time, then in some embodiments, the personalization and/or upgrade test application may cause a warning message to be displayed 718, such as: “warning: payment application has not been tested,” on the display component of the user's payment-enabled mobile device, and the process ends. In some embodiments, the personalization and/or upgrade test application may also transmit a warning message, such as: “warning: payment application untested” to the issuer FI server computer, which may or may not cause the issuer FI to take action. For example, the issuer FI server computer may then contact the user via SMS message or e-mail to prompt the cardholder to engage in a zero value purchase transaction test, or the issuer FI server computer may notify a customer care representative who may then call the user.

Referring again to FIG. 7, if in step 716 user input is received by the user's payment-enabled mobile device then the personalization and/or upgrade test application may transmit 720 a request for a unique number to the issuer FI server computer. The issuer FI server computer may then utilize a random number generator or other apparatus or process to generate a unique number, and then transmit the unique number to the user's payment-enabled mobile device. Next, when the unique number is received, in some implementations the personalization and/or upgrade test application generates 722 a cryptogram. The personalization and/or upgrade test application then transmits 724 the cryptogram and a zero value purchase request to the issuer FI server computer. Upon receipt of the cryptogram, the issuer FI server computer attempts to validate the cryptogram. If the cryptogram is validated, then the issuer FI server computer performs a conventional purchase transaction authorization process, and if the purchase transaction is validated and/or authorized, then the issuer FI server computer transmits a zero value purchase transaction authorization message or a verification message back to the mobile device. Thus, if a zero value purchase transaction authorization message or a verification message is received 726 by the user's payment-enabled mobile device (for example, within a predetermined amount of time after transmitting the cryptogram) then in some embodiments, the personalization and/or upgrade test application generates a success message that is displayed 728 on a display component of the user's payment-enabled mobile device so that the user can be confident that his or her payment-enabled mobile device will function correctly as a contactless payment device.

However, if in step 726 a verification message is not received within a predetermined amount of time by the user's payment-enabled mobile device, then in some implementations the system automatically attempts to troubleshoot 730 the problem. For example, the personalization/upgrade test application may obtain data from one or more usage logs of the payment-enabled mobile device, for example, data from an NFC field log (which may indicate the number of times near field communications (NFC) occurred, and/or when the last NFC communication occurred), and then communicate or report such data OTA to an MNO computer and/or to an issuer FI server computer. Such data may be utilized by the MNO computer and/or by the issuer FI server computer to remotely troubleshoot and/or remotely debug the problem and/or to automatically fix the problem. For example, the data from a mobile device usage log may indicate that it is the first time an attempt is being made to load a payment application into this mobile device, but the NFC field log indicates that other NFC applications of the mobile device have been working correctly and that an NFC application operated correctly yesterday afternoon at 5:30 pm when the mobile device “checked-in” at a local coffee shop. In this case, it may be assumed that the NFC circuitry is working correctly, and thus attention can be focused on other issues and/or other mobile device circuitry that may be causing the problem. If a problem is found and an automatic fix is applied (or received by the mobile device), then in some embodiments the personalization and/or upgrade test application will again generate a cryptogram based on the unique number and transmit the cryptogram and a zero value purchase request to the issuer FI computer. If the cryptogram is deemed valid by the issuer FI, then the issuer FI computer performs a conventional purchase transaction authorization process using the zero value purchase transaction data. When the issuer FI computer validates and/or authorizes the zero-value purchase transaction, the issuer FI transmits a purchase transaction authorization message or verification message back to the mobile device. When the verification message is received 732, then a success message is displayed 728 on the mobile device display screen so that the user knows that the mobile device can now be used as a payment device. In this scenario, the cardholder or mobile device owner may never have been made aware of any problem with his or her mobile device with regard to the loading and/or functionality of the payment application. However, if in step 732 the verification message is not received within a second predetermined period of time, then the personalization and/or upgrade test application may cause the mobile device to display 734 of a failure message on the display component.

It should be understood that, in some embodiments the troubleshooting step 730 may involve multiple tries at correcting or fixing the problem, which may take milliseconds up to several seconds or more in real time to try. In such cases, the mobile device usage logs, such as the NFC field log, play an important role when the system is attempting to remotely resolve the NFC problem as explained above. In addition, when an NFC issue cannot be resolved remotely, the failure message may include instructions for the cardholder or user to retry the entire personalization process from the beginning, and/or to contact a customer care representative of his or her MNO, and/or to contact a representative of the issuer FI to troubleshoot the OTA personalization process.

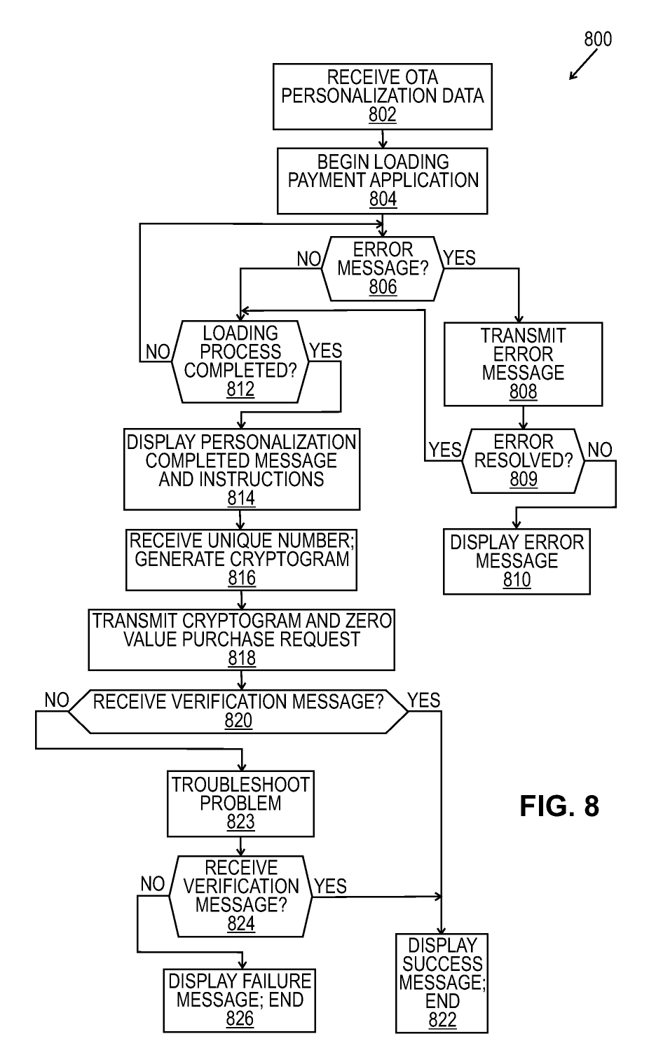

FIG. 8 is a flowchart 800 illustrating a payment application personalization and customer care testing process according to an embodiment. A payment-enabled mobile device receives 802 OTA personalization data, and begins loading the 804 the payment application onto a secure element of the user's payment-enabled mobile device. In some implementations, as loading progresses feedback from each individual command or application protocol data unit (APDU) is analyzed, and if a problem is detected then in step 806 an error message is generated, and the error message is transmitted 808 to the issuer FI computer. When an error is detected during loading of the payment application, in some embodiments the system may make one or more additional attempts to correctly load the payment application or to otherwise resolve the problem. For example, the payment-enabled mobile device may be operable to communicate OTA with an issuer FI server computer and/or with an MNO computer to troubleshoot the problem and/or to automatically fix the problem. However, if in step 809 the system cannot resolve the problem, then an error message or warning message may be displayed 810 on a display component of the user's payment-enabled mobile device so that the user is made aware that the personalization process failed such that the payment-enabled mobile device cannot be used as a payment device, and the process ends. In this case, in some embodiments instructions may also be provided to the user regarding how best to proceed. For example, depending on which portion of the personalization process an error message occurred, the cardholder or user may be notified and/or prompted to retry the personalization process, and/or to contact a customer care representative of his or her MNO, and/or to contact the issuer FI to troubleshoot the OTA personalization process.

Referring again to FIG. 8, if there are no error messages in step 806, or if the error was resolved in step 809, then the personalization and/or upgrade test application may check to see if loading of the personalized payment application has completed 812. If the loading has not yet completed, then the process loops back to step 806 wherein another check for any error messages occurs. But if it is found in step 812 that the personalized payment application loading process has completed, then in some embodiments the personalization and/or upgrade test application causes the user's payment-enabled mobile device display 814 a personalization completed message and instructions on a display component of the user's payment-enabled mobile device. In some embodiments, the user or cardholder may be instructed to contact an issuer customer care center and/or issuer representative, for example, via a website or via a customer care telephone number. In some embodiments, the customer care representative and or an online customer care application may initialize a process to generate a unique number and then to transmit the unique number to the user's payment-enabled mobile device with an instruction that initializes a personalization and/or upgrade test application on the user's payment-enabled mobile device.

Referring again to FIG. 8, when the mobile device receives 816 the unique number from the issuer FI server computer, in some implementations the personalization and/or upgrade test application generates a cryptogram. The personalization and/or upgrade test application then transmits 818 the cryptogram and a zero value purchase request to the issuer FI server computer. Upon receipt of the cryptogram, the issuer FI server computer attempts to validate the cryptogram. If the cryptogram is validated, then the issuer FI server computer performs a conventional purchase transaction authorization process, and if the purchase transaction is validated and/or authorized, then the issuer FI server computer transmits a zero value purchase transaction authorization message or a verification message back to the mobile device. Thus, if a zero value purchase transaction authorization message or a verification message is received 820 by the user's payment-enabled mobile device (for example, within a predetermined amount of time after transmitting the cryptogram) then in some embodiments, the personalization and/or upgrade test application generates a success message that is displayed 822 on a display component of the user's payment-enabled mobile device so that the user can be confident that his or her payment-enabled mobile device will function correctly as a contactless payment device, and the process ends.

However, if in step 820 a verification message is not received within a predetermined amount of time by the user's payment-enabled mobile device, then in some implementations the system automatically attempts to troubleshoot 823 the problem. For example, the personalization/upgrade test application may obtain data from one or more usage logs of the payment-enabled mobile device, for example, data from an NFC field log (which may indicate the number of times near field communications (NFC) occurred, and/or when the last NFC communication occurred), and then communicate or report such data OTA to an MNO computer and/or to an issuer FI server computer. Such data may be utilized by the MNO computer and/or by the issuer FI server computer to remotely troubleshoot and/or remotely debug the problem and/or to automatically fix the problem. For example, if the NFC field log indicates that other NFC applications have not been operated for two weeks, then it may be assumed that the NFC circuitry may be faulty and/or not working correctly. In such a case, attention may be focused on the NFC circuitry and several diagnostic tests run to determine whether or not one of the NFC components is malfunctioning and/or whether or not an NFC application is faulty. If a problem is found and an automatic fix is applied or received by the mobile device (for example, updated NFC driver circuitry has been downloaded, installed and is working), then in some embodiments the personalization and/or upgrade test application will again generate a cryptogram based on the unique number and transmit the cryptogram and a zero value purchase request to the issuer FI computer. If the cryptogram is deemed valid by the issuer FI, then the issuer FI computer performs a conventional purchase transaction authorization process using the zero value purchase transaction data. When the issuer FI computer validates and/or authorizes the zero-value purchase transaction, the issuer FI transmits a purchase transaction authorization message or verification message back to the mobile device. When the verification message is received 824, then a success message is displayed 822 on the mobile device display screen so that the user knows that the mobile device can now be used as a payment device. In this scenario, the user or mobile device owner may never have been made aware of any problem with regard to the loading and/or functionality of the payment application. However, if in step 824 the verification message is not received within a second predetermined period of time, then the personalization and/or upgrade test application may cause the mobile device to display 826 a warning message or a failure message on the display component.

It should be understood that, in some embodiments troubleshooting may involve multiple tries at correcting or fixing the problem, which may take milliseconds up to several seconds or more in real time to try. In such cases, the mobile device usage logs, such as the NFC field log, play an important role when the system is attempting to remotely resolve the NFC problem. In addition, when an NFC issue cannot be resolved remotely, the warning message or failure message displayed to the user may include instructions for the cardholder or user to retry the entire personalization process from the beginning, and/or to contact a customer care representative of his or her MNO, and/or to contact a representative of the issuer FI to troubleshoot the OTA personalization process.

Aspects of the methods described above have been disclosed with reference to a payment-enabled mobile telephone. However, it should be understood that the principles described in this disclosure are also applicable to other types of mobile devices configured to store instructions and/or data and that are at times controlled by a payment application. Any and all such devices, including payment-enabled mobile telephones, should be understood as included in the term “payment-enabled mobile device”.

Relative to a payment-enabled mobile device and a proximity reader, the term “tap” refers either to brief physical contact, or relative positioning such that wireless communication occurs.

As used herein and in the appended claims, the term “computer” should be understood to encompass a single computer or two or more computers in communication with each other or a computer network or computer system.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices. Such a memory and/or storage device may include any and all types of non-transitory computer-readable media, with the sole exception being a transitory, propagating signal.

The flow charts and descriptions thereof herein should not be understood to prescribe a fixed order of performing the method steps described therein. Rather, the method steps may be performed in any order that is practicable. In addition, the flow charts described herein should not be understood to require that all steps or elements be practiced in every embodiment. For example, one or more elements or steps may be omitted in some embodiments.

As used herein and in the appended claims, the term “payment card account” includes a credit card account or a deposit account or other type of financial account that an account holder may access. The term “payment card account number” includes a number that identifies a payment card system account or a number carried by a payment card, or a number that is used to route a transaction in a payment system that handles debit card and/or credit card transactions. The term “payment card” may include, but is not limited to a credit card, a debit card, a transit card, an identification card, a loyalty card, and/or a gift card.

As used herein and in the appended claims, the terms “payment card system” and/or “payment network” refer to a system and/or network for handling purchase transactions and related transactions, which may be operated by a payment card system operator such as MasterCard International Incorporated, or a similar system. In some embodiments, the term “payment card system” may be limited to systems in which member financial institutions (such as banks) issue payment card accounts to individuals, businesses and/or other organizations.

Although the present disclosure describes specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
detecting, by a processor of a payment-enabled mobile device, completion of an over the air (OTA) payment application personalization process;
transmitting, by the processor to an issuer financial institution (FI) computer, a request for a unique number;
receiving the unique number;
generating, by the processor based on the unique number, a cryptogram;
transmitting the cryptogram and a zero value purchase amount transaction request to the issuer FI computer; and
receiving, by the processor, a zero value transaction authorization message from the issuer FI computer indicating that the payment application successfully loaded and is functional.

2. The method of claim 1, further comprising displaying, by a display component of the payment-enabled mobile device, a payment application load success message.

3. The method of claim 1, further comprising:
receiving, by the processor, instructions to delete a back level payment application from a secure element of the payment-enabled mobile device; and
deleting, by the processor, the back level payment application.

4. The method of claim 1, prior to receiving the zero value transaction authorization message:
determining, by the processor, that a predetermined time period for receiving the zero value transaction authorization message expired which indicates a problem;
troubleshooting, by the processor, the problem;
applying a solution;
transmitting, by the processor to an issuer financial institution (FI) computer, a second request for a unique number when the solution appears to have fixed the problem;
receiving a second unique number;
generating a cryptogram based on the second unique number;
transmitting the cryptogram and a second zero value purchase amount transaction request to the issuer FI computer; and
receiving, by the processor, a zero value transaction authorization message from the issuer FI computer indicating that the payment application successfully loaded and is functional.

5. The method of claim 4, wherein troubleshooting comprises transmitting, by the processor, an error message and mobile device data to a remote computer to diagnose the problem.

6. The method of claim 5, wherein the mobile device data comprises data stored in mobile device near-field communication (NFC) usage log files.

7. The method of claim 5, wherein applying a solution comprises:
loading, by the processor, instructions configured to fix the problem; and
executing the instructions.

8. The method of claim 1, prior to receiving the authorization message:
determining, by the processor, that a predetermined time period for receiving the zero value transaction authorization message expired which indicates a problem;
attempting, by the processor, to troubleshoot the problem;
determining that the problem has not been resolved; and
displaying, by the processor on a mobile device display component, a warning message indicating that the mobile device is not operable to function as a payment device.

9. The method of claim 1, further comprising, prior to detecting completion of the OTA payment application personalization process:
receiving, by the processor, OTA instructions to upgrade a payment application onto a secure element of the payment-enabled mobile device; and
loading, by the processor, the upgraded payment application onto the secure element.

10. The method of claim 9, further comprising, subsequent to receiving the zero value transaction authorization message:
receiving, by the processor, instructions to delete a previously loaded payment application from the secure element; and
deleting, by the processor, the previously loaded payment application.

11. The method of claim 1, further comprising, subsequent to detecting completion of the OTA payment application personalization process:
displaying, by the processor on the display component, a payment application test request message; and
receiving, by the processor from a user, input requesting testing of the payment application.

12. The method of claim 11, further comprising, subsequent to displaying the payment application test request message on the display component:
determining, by the processor, that input requesting testing has not been received within a predetermined period of time; and
displaying, by the processor on the display component, a warning message indicating that the payment application is untested.

13. A non-transitory computer readable medium storing instructions configured to cause a mobile device processor to:
detect completion of an over the air (OTA) payment application personalization process;
transmit a request for a unique number to an issuer financial institution (FI) computer;
receive the unique number;
generate a cryptogram based on the unique number;
transmit the cryptogram and a zero value purchase amount transaction request to the issuer FI computer; and
receive a zero value transaction authorization message from the issuer FI computer indicating that the payment application successfully loaded and is functional.

14. The non-transitory computer readable medium of claim 13, further comprising instructions to cause the processor to display a payment application load success message on a display component of the mobile device.

15. The non-transitory computer readable medium of claim 13, further comprising instructions to cause the processor to:
receive instructions to delete a back level payment application from a secure element of the payment-enabled mobile device; and
delete the back level payment application.

16. The non-transitory computer readable medium of claim 13, further comprising, prior to the instructions for receiving the zero value transaction authorization message, instructions to cause the processor to:
determine that a predetermined time period for receiving the zero value transaction authorization message expired which indicates a problem;
troubleshoot the problem;
apply a solution;
transmit a second request for a unique number to an issuer financial institution (FI) computer when the solution appears to have fixed the problem;
receive a second unique number;
generate a cryptogram based on the second unique number;
transmit the cryptogram and a second zero value purchase amount transaction request to the issuer FI computer; and
receive a zero value transaction authorization message from the issuer FI computer indicating that the payment application successfully loaded and is functional.

17. The non-transitory computer readable medium of claim 13, further comprising, prior to the instructions for receiving the authorization message, instructions to cause the processor to:
determine that a predetermined time period for receiving the zero value transaction authorization message expired which indicates a problem;
attempt to troubleshoot the problem;
determine that the problem has not been resolved; and
display a warning message on a mobile device display component indicating that the mobile device is not operable to function as a payment device.

18. The non-transitory computer readable medium of claim 13, further comprising, prior to the instructions for detecting completion of the OTA payment application personalization process, instructions to cause the processor to:
receive OTA instructions to upgrade a payment application onto a secure element of the payment-enabled mobile device; and
load the upgraded payment application onto the secure element.

19. The non-transitory computer readable medium of claim 18, further comprising, subsequent to the instructions for receiving the zero value transaction authorization message, instructions to cause the processor to:
receive instructions to delete a previously loaded payment application from the secure element; and
delete the previously loaded payment application.

20. The non-transitory computer readable medium of claim 13, further comprising, subsequent to the instructions for detecting completion of the OTA payment application personalization process, instructions to cause the processor to:
display a payment application test request message on the display component; and
receive input from a user requesting testing of the payment application.

21. The non-transitory computer readable medium of claim 20, further comprising, subsequent to the instructions for displaying the payment application test request message, instructions to cause the processor to:
determine that input requesting testing has not been received within a predetermined period of time; and
display a warning message on the display component indicating that the payment application is untested.

22. A payment-enabled mobile device, comprising:
a processor;
transmit and receive circuitry operably coupled to the processor and to an antenna;
a transceiver operably coupled to the processor and to a payment processing antenna, the transceiver operable to exchange wireless signals via the payment processing antenna with a reader device; and
a non-transitory memory operably coupled to the processor and storing instructions configured to cause the processor to:
detect completion of an over the air (OTA) payment application personalization process;
transmit a request for a unique number to an issuer financial institution (FI) computer;
receive the unique number;
generate a cryptogram based on the unique number;
transmit the cryptogram and a zero value purchase amount transaction request to the issuer FI computer; and
receive a zero value transaction authorization message from the issuer FI computer indicating that the payment application successfully loaded and is functional.
